(19) United States
(12) Patent Application Publication
(10) Pub. No.: US 2010/0008640 A1
(43) Pub. Date: Jan. 14, 2010

(54) SYSTEM AND METHOD FOR ACQUIRING AND EDITING AUDIO DATA AND VIDEO DATA

(75) Inventor: Edward Marion Casaccia, Carmichael, CA (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-Billancourt (FR)

(21) Appl. No.: 12/312,971

(22) PCT Filed: Dec. 13, 2006
(86) PCT No.: PCT/US2006/047577

§ 371 Date: Jun. 2, 2009

(51) Int. Cl. G11B 27/00

(52) U.S. Cl. 386/54; 386/E05.028

(57) ABSTRACT

There is provided a system for acquiring video data and audio data. In an exemplary embodiment, the system comprises a camera that is adapted to acquire video data suitable for recording on a tangible medium, the video data being representative of an image of a subject taken at an azimuth value relative to the subject, a microphone that is adapted to acquire audio data that corresponds to the video data on the tangible medium, the microphone being adapted to acquire the audio data from the azimuth value relative to the subject, and a compass that is adapted to provide data corresponding to the azimuth data, the azimuth data being stored along with the corresponding video data and audio data on the tangible medium.

### FIELD OF THE INVENTION

The present invention relates to improving the editing of multi-directional audio in news and other field acquisition productions.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

The transition to high definition television has created special challenges in the field of audio editing in television news gathering and production. Specifically, the use of “surround sound,” “5.1 audio,” “6.1 audio” and other technologies that provide the audience the aural impression of being surrounded by the actual audio environment experienced in the field currently implies an extremely tedious and labor intensive editing process.

The nature of editing news and other field acquisition material may exacerbate this situation. Frequently in on-site television reporting, many shots taken from different directions are edited together as short clips. The varying shots are typically shown in rapid sequence as a final audiovisual product. Changing the audio perspective frequently to account for the changes in shot direction may be esthetically objectionable, and indeed may be irritating to the audience. The only known method to overcome these problems involves manually aligning the direction from which the audience perceives the audio for each shot as it is edited into a finished audio-visual product. This process is complex and time consuming. An improved system and method that simplifies the process of directional sound editing and provides an effect that is pleasing to a listener is desirable.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

There is provided a system for acquiring video data and audio data. In an exemplary embodiment, the system comprises a camera that is adapted to record video data on a tangible medium, the video data being representative of an image of a subject taken at an azimuth value relative to the subject, a microphone that is adapted to record audio data that corresponds to the video data on the tangible medium, the microphone being adapted to record the audio data from the azimuth value relative to the subject, and a compass that is adapted to provide data corresponding to the azimuth data, the azimuth data being stored along with the corresponding video data and audio data on the tangible medium.

Also provided is an editing system. An exemplary editing system comprises a recorded medium that stores video data, audio data and associated azimuth data. The exemplary system further comprises an editor that is adapted to receive the video data, the audio data and the associated azimuth metadata, adjust a perceived direction of a portion of the audio data corresponding to a portion of the video data so that the perceived direction of the portion of the audio data corresponds to an azimuth adjusted value, the azimuth adjusted value corresponding to a relative azimuth with reference to an azimuth of a different portion of the video data representing a master perspective, and create a finished audiovisual work using the azimuth adjusted value for the portion of audio data corresponding to the portion of the video data.

In addition, a method of editing video data and audio data is provided. An exemplary embodiment of the method comprises receiving recorded video data, recorded audio data and associated azimuth metadata. The exemplary method further comprises adjusting a perceived direction of a portion of the audio data corresponding to a portion of the video data so that the perceived direction of the portion of the audio data corresponds to an azimuth adjusted value, the azimuth adjusted value corresponding to a relative azimuth with reference to an azimuth of a different portion of the video data representing a master perspective, and creating a finished audiovisual work using the azimuth adjusted value for the portion of audio data corresponding to the portion of the video data.

Also disclosed is a recorded medium having recorded thereon video data, audio data and azimuth data, the azimuth data representing an orientation of a microphone that produced the audio data. Alternatively is disclosed a recorded medium having recorded thereon video data portraying a first image, edited audio data and azimuth data such that said edited audio data are adjusted to a perceived direction that corresponds to an azimuth of a second video image.

### BRIEF DESCRIPTION OF THE DRAWINGS

In the drawings:

FIG. 1 is block diagram of a system in accordance with an exemplary embodiment of the present invention;

FIG. 2 is a block diagram of a non-linear editing system in accordance with an exemplary embodiment of the present invention; and

FIG. 3 is a process flow diagram showing a process in accordance with an exemplary embodiment of the present invention.

### DETAILED DESCRIPTION OF THE PREFERRED EMBODIMENT

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

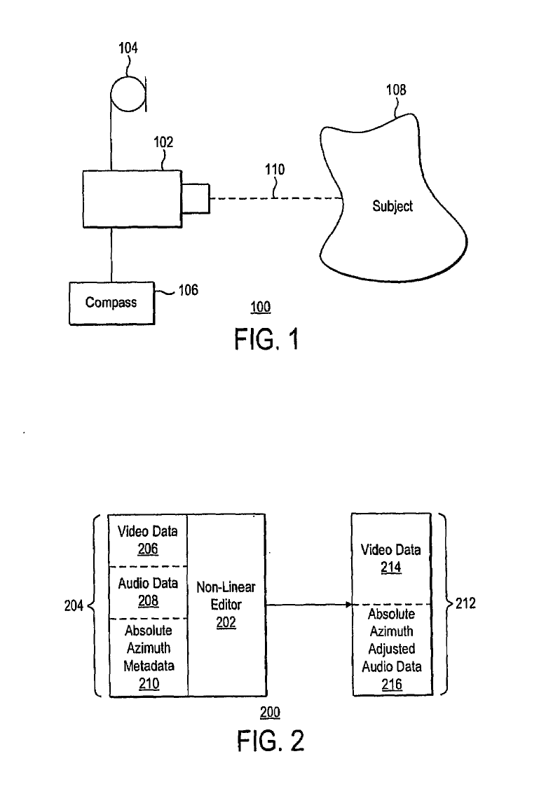

FIG. 1 is block diagram of a system in accordance with an exemplary embodiment of the present invention. The diagram is generally referred to by the reference number 100. The system shown in FIG. 1 comprises a camera 102, a directional microphone 104 and a compass 106. The camera 102 may comprise a camcorder or the like. In an exemplary embodiment of the present invention, the directional microphone 104 and the compass 106 are physically coupled or integrated into a single unit that includes the camera 102. In an alternative exemplary embodiment, the directional microphone 104 is not physically integrated or coupled to the camera 102, but instead is adapted to point at a subject 108 (or record sound as though pointed at the subject 108) from the same direction as the camera 102. Additionally, the compass 106 is adapted to provide an indication of a direction in which the microphone 104 is directed. In the exemplary embodiment illustrated in FIG. 1, the direction is illustrated by a dashed line 110.

The directional data (i.e., the direction in which the microphone 104 is directed) is referred to herein as absolute azimuth data, where absolute azimuth may refer to a compass direction with respect to the earth's axes. Absolute azimuth is often referred to simply as “azimuth”. In an exemplary embodiment of the present invention, the absolute azimuth data is stored as metadata on a medium recorded by the camera 102 in association with the corresponding audiovisual information recorded by the camera 102. Thus, the absolute azimuth data for any portion of the recorded information is preserved for later use along with the recorded audiovisual information.

In an exemplary embodiment of the present invention, audio parameters such as level, balance and the like are controllable via an interface with the camera 102. Microphone “zoom” (i.e., narrowed audio perspective) may be adapted to follow actual camera video zoom.

FIG. 2 is a block diagram of a non-linear editing system in accordance with an exemplary embodiment of the present invention. The non-linear editing system is generally referred to by the reference number 200. A non-linear editor 202 is adapted to receive data stored on a storage medium 204, which is recorded by the camera 102 (FIG. 1). The storage medium 204 comprises video data 206, audio data 208 and absolute azimuth metadata 210. The absolute azimuth metadata 210 relate to the video data 206 and the audio data 208 by giving the absolute azimuth 110 of the microphone 104 (FIG. 1) for the corresponding video data 206 and audio data 208. Moreover, the absolute azimuth data 210 provide a constant source of position data for any given set of corresponding Video data 206 and audio data 208 on the recorded medium 204.

In an exemplary embodiment of the present invention, the non-linear editor 202 is adapted to read the absolute azimuth data 210 for each shot and place the data on a timeline. An operator of the non-linear editor 202 may select one shot as the master audio perspective for the entire timeline. In an exemplary embodiment of the present invention, the non-linear editor 202 is adapted to automatically adjust the perceived direction (relative azimuth) of the audio data to the other clips on the timeline to match the master perspective. In this context, relative azimuth refers to a direction with respect to other than the earth's axes. The result of the editing process is a finished recorded medium 212 that comprises video data 214 and azimuth adjusted audio data 216.

By way of example, assume that a shot with an absolute azimuth value of 270° is selected as the master perspective for an audiovisual work. An accompanying scene shot at an absolute azimuth value of 90° would be automatically adjusted by the non-linear editor 202 to have an azimuth adjusted value of 270°, or stated differently, a relative azimuth of 180°, that being the rotation of the image necessary to align with the master perspective. In an exemplary embodiment of the present invention, the non-linear editor 202 is provided with a fine tuning control to perform adjustment of the absolute azimuth adjusted value as needed.

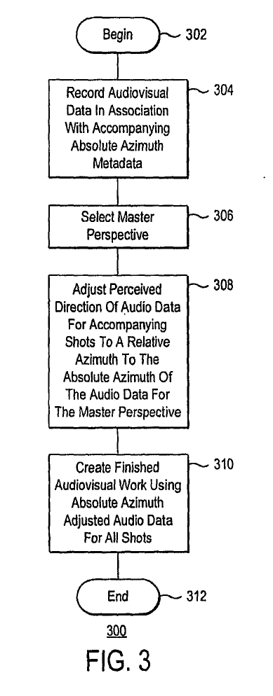

FIG. 3 is a process flow diagram showing a process in accordance with an exemplary embodiment of the present invention. The process is generally referred to by the reference number 300. At block 302, the process begins.

At block 304, a non-linear editor such as the non-linear editor 202 (FIG. 2) receives video data 206 (FIG. 2), audio data 208 (FIG. 2) and associated absolute azimuth metadata 210 (FIG. 2). During editing into a finished audiovisual work 212 (FIG. 2), a master perspective is selected for the finished audiovisual work, as shown at block 306. The perceived direction of audio data for a portion of the audio data (i.e., audio data for accompanying shots taken at an angle relative to the absolute azimuth value of the master perspective) is adjusted to a relative azimuth with reference to the absolute azimuth of the audio data for the master perspective. The resulting audio data is referred to as azimuth adjusted audio data 216 (FIG. 2) because the absolute azimuth of that audio data has been adjusted based on the-absolute azimuth of the master perspective.

At block 310, the finished audiovisual work 212 (FIG. 2) is created using the absolute azimuth adjusted audio data for all shots. At block 312, the process ends.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1-7. (canceled)

8. An editing system, comprising:
a recorded medium that stores video data, audio data and associated azimuth data;
an editor that is adapted to:
receive the video data, the audio data and the associated azimuth data;
adjust a perceived direction of a portion of the audio data corresponding to a portion of the video data so that the perceived direction of the portion of the audio data corresponds to an azimuth adjusted value, the azimuth adjusted value corresponding to a relative azimuth with reference to an azimuth of a different portion of the video data representing a master perspective; and
create a finished audiovisual work using the azimuth adjusted value for the portion of audio data corresponding to the portion of the video data.

9. The editing system as recited in claim 8, wherein the editor comprises a non-linear editor.

10. The editing system as recited in claim 8, wherein the editor is adapted to allow a user to select the master perspective.

11. The editing system as recited in claim 8, wherein the azimuth data comprise metadata.

12. The editing system as recited in claim 8, wherein the azimuth is defined to be with respect to an angle relative to a subject.

13. The editing system as recited in claim 8, wherein the editing system comprises a fine tuning control to perform adjustment of the azimuth adjusted value in the finished audiovisual work.

14. A method of editing video data and audio data, comprising:
receiving video data, audio data and associated azimuth data; and
adjusting a perceived direction of a portion of the audio data corresponding to a portion of the video data so that the perceived direction of the portion of the audio data corresponds to an azimuth of a different portion of the video data representing a master perspective.

15. The method as recited in claim 14, comprising selecting the master perspective.

16. The method as recited in claim 14, wherein the azimuth data comprise metadata.

17. The method as recited in claim 14, comprising defining the perceived direction to be with respect to an angle of 0° relative to a subject.

18. The method as recited in claim 14, comprising performing a fine tuning adjustment of the perceived direction to include in the finished audiovisual work.

19. The method as recited in claim 14, comprising acquiring the audio data with a directional microphone.

20. The method as recited in claim 14, comprising recording the acquired video data, the acquired audio data and the associated azimuth data.

21. The method as recited in claim 20, comprising recording the acquired video data, the acquired audio data and the associated azimuth data with a camcorder.

22. A recorded medium having recorded thereon video data, audio data and azimuth data, said azimuth data representing an orientation of a microphone that produced said audio data said video data portraying a first image, an edited version of said audio data and said azimuth data such that said edited audio data are adjusted to a perceived direction that corresponds to an azimuth of a second video image.

23. (canceled)
